(19) United States
(12) Patent Application Publication
(10) Pub. No.: US 2010/0053645 A1
(43) Pub. Date: Mar. 4, 2010

(54) METHOD FOR PROCESSING DATA AND RECORDING MEDIA RECORDED WITH PROGRAM REALIZING THE SAME

(75) Inventors: Shang-Hoon Seo, Seoul (KR); Jae-Woo Joung, Suwon-si (KR); Ro-Woon Lee, Seoul (KR); Yong-Sik Kim, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/430,474

(22) Filed: Apr. 27, 2009

(30) Foreign Application Priority Data
Aug. 28, 2008 (KR) 10-2008-0084383

(51) Int. Cl. G06F 15/00

(52) U.S. Cl. 358/1.9

(57) ABSTRACT

Disclosed are a method for processing data and a recording media recorded with a program realizing the same. The method for processing bitmap data for driving an inkjet head in which nozzle rows are spaced from one another in a scan direction, each of the nozzle rows consisting of a plurality of nozzles disposed on the same straight line, the method including: converting a distance by which a second nozzle row is spaced from a first nozzle row in the scan direction into a pixel count of the bitmap data; and compensating the bitmap data for driving the second nozzle row by as much as the pixel count.

### CROSS-REFERENCE TO RELATED APPLICATIONS

This application claims the benefit of Korean Patent Application No. 10-2008-0084383, filed with the Korean Intellectual Property Office on Aug. 28, 2008, the disclosure of which is incorporated herein by reference in its entirety.

### BACKGROUND

1. Technical Field

The present invention relates to a method for processing data and a recording media recorded with a program realizing the same.

2. Description of the Related Art

The inkjet technology makes it possible to print on various materials without contact. The inkjet technology has been recently applied to the field of display, especially in organic light emitting diodes (OLED) and liquid crystal displays (LCD) as well as in the manufacture of radio frequency identification (RFID) devices and plastic semiconductors.

While the earlier inkjet technology used an inkjet head having a single nozzle for printing, more recent inkjet technologies have adopted an inkjet head having multiple nozzles, in which rows of nozzles consisting of a plurality of nozzles are disposed, in order to incorporate as many nozzles as possible within the limited area of the inkjet head for better productivity with the given printing speed and time.

However, in case that printing data consisting of pixels are matched with the nozzle rows of the inkjet head and are printed in the scan direction by using the inkjet head having the multiple nozzle row structure, there occurs an adhesion error of ink drops by as much as the space distance since the multiple nozzle rows are spaced from one another in the scan direction.

### SUMMARY

The present invention provides a method of processing data, which is capable of reducing adhesion error of a drop of ink being discharged from an inkjet head, and provides a recording media recorded with a program realizing the same.

An aspect of the present invention features a method for processing bitmap data for driving an inkjet head in which nozzle rows are spaced from one another in a scan direction, each of the nozzle rows consisting of a plurality of nozzles disposed on the same straight line. The method in accordance with the embodiment of the present invention can include converting a distance by which a second nozzle row is spaced from a first nozzle row in the scan direction into a pixel count of the bitmap data; and compensating the bitmap data for driving the second nozzle row by as much as the pixel count.

Here, the converting of the spaced distance into the pixel count can include computing a pixel size by inverting a dot per inch (DPI) of the bitmap data; and computing the pixel count by taking an integer of a quotient of the spaced distance divided by the pixel size.

The compensating of the bitmap data can include subtracting the pixel count from a coordinate value in the scan direction of the bitmap data for driving the second nozzle row.

Another aspect of the present invention features a recording media recorded with a program for realizing a method for processing bitmap data for driving an inkjet head in which nozzle rows are spaced from one another in a scan direction, each of the nozzle rows consisting of a plurality of nozzles disposed on the same straight line. The method in accordance with the embodiment of the present invention can include converting a distance by which a second nozzle row is spaced from a first nozzle row in the scan direction into a pixel count of the bitmap data: and compensating the bitmap data for driving the second nozzle row by as much as the pixel count.

Here, the converting of the spaced distance into the pixel count can include computing a pixel size by inverting a dot per inch (DPI) of the bitmap data; and computing the pixel count by taking an integer of a quotient of the spaced distance divided by the pixel size.

The compensating of the bitmap data can include subtracting the pixel count from a coordinate value in the scan direction of the bitmap data for driving the second nozzle row.

### BRIEF DESCRIPTION OF THE DRAWINGS

FIG. 1 is a bottom view showing an inkjet head printing a pattern by using bitmap data compensated according to a method for processing data in accordance with an embodiment of the present invention.

FIG. 2 is a flowchart showing a method for processing data in accordance with an embodiment of the present invention.

FIG. 3 is shows bitmap data, illustrated on a plane, before being compensated according to a method for processing data in accordance with an embodiment of the present invention.

FIG. 4 shows bitmap data, illustrated on a plane, compensated according to a method for processing data in accordance with an embodiment of the present invention.

### DETAILED DESCRIPTION

Embodiments of a method for processing data and recording media recorded with a program realizing the same will be described in detail with reference to the accompanying drawings. In description with reference to accompanying drawings, the same reference numerals will be assigned to the same or corresponding elements, and repetitive description thereof will be omitted.

Hereinafter, terms such as “first” and “second” are just identification symbols for distinguishing the same or corresponding elements. The same or corresponding elements will not be restricted to the above terms.

According to an embodiment of the present invention, provided is a method for processing bitmap data for driving an inkjet head in which nozzle rows are spaced from one another in a scan direction, each of the nozzle rows consisting of a plurality of nozzles disposed on the same straight line. The method in accordance with the embodiment of the present invention can include converting a distance by which a second nozzle row is spaced from a first nozzle row in the scan direction into a pixel count of the bitmap data; and compensating the bitmap data for driving the second nozzle row by as much as the converted pixel count.

According to the embodiment of the present invention, there can be less error in the position of a printing object to which an ink drop is adhered, enhancing the print quality.

Hereinafter, while an inkjet head consisting of two nozzle rows will be taken as an example of the present invention, it shall be evident that the method for processing data in accordance with an embodiment of the present invention can be also applied to an inkjet head consisting of at least three nozzle rows.

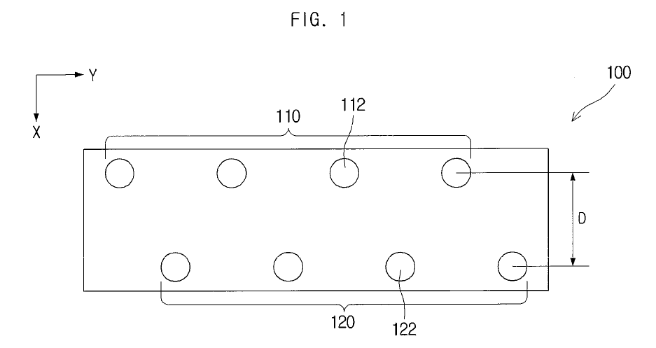

Hereinafter, steps of the method for processing data in accordance with an embodiment of the present invention will be described in detail with reference to FIGS. 1 through 4, respectively.

Prior to describing the steps of an embodiment of the present invention, an inkjet head 100 printing a pattern by use of bitmap data 140 compensated according to an embodiment of the present invention will be described with reference to FIG. 1.

FIG. 1 is a bottom view showing an inkjet head 100 printing a pattern by using bitmap data 140 compensated by means of a method for processing data in accordance with an embodiment of the present invention.

In FIG. 1, an inkjet head 100 includes a plurality of nozzle rows 110 and 120 spaced from one another in a scan direction X. The plurality of nozzle rows 110 and 120 consist of a plurality of nozzles 112 and 122 respectively and the plurality of nozzles 112 and 122 are disposed on the same straight line respectively. That is, a first nozzle row 110 and a second nozzle row 120 are constituted by disposing the plurality of nozzles 112 and 122 on one imaginary straight line. The second nozzle row 120 is disposed separately on the basis of the first nozzle row 110 in the scan direction X. Here, each of the nozzles 122 is, as shown in FIG. 1, disposed between the nozzles 112 of the first nozzle row 110 with respect to a direction Y perpendicular to the scan direction X, so that the overall nozzles 112 and 122 are disposed in a zigzag shape.

The scan direction X refers to a direction in which printing is performed on a printing object according as the inkjet head 100 or the printing object moves, and refers to a direction in which a coordinate value increases on the bitmap data. In the embodiment of the present invention, as shown in FIG. 1, the scan direction X is perpendicular to the first nozzle row 110 and the second nozzle row 120, and corresponds to a direction from the first nozzle row 110 to the second nozzle row 120.

In the next place, a method for processing data in accordance with an embodiment of the present invention will be described with reference to FIGS. 1 through 4.

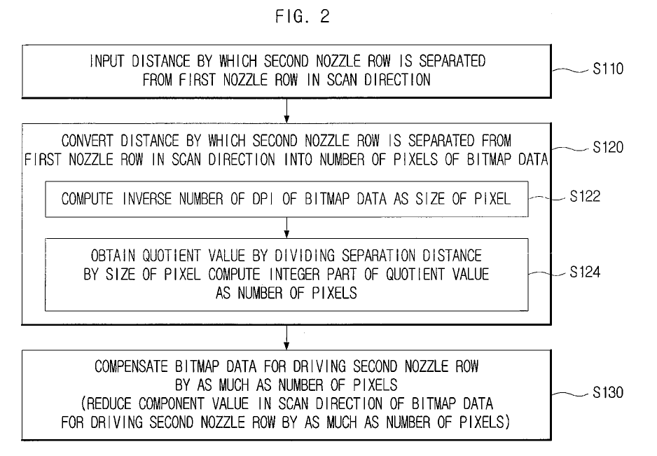

FIG. 2 is a flowchart showing a method for processing data in accordance with an embodiment of the present invention.

First, bitmap data 130 and a distance D by which the second nozzle row 120 is spaced from the first nozzle row 110 in the scan direction X are input (S110). The distance D by which the second nozzle row 120 is spaced from the first nozzle row 110 in the scan direction X is a predetermined value at the time of designing the inkjet head 100.

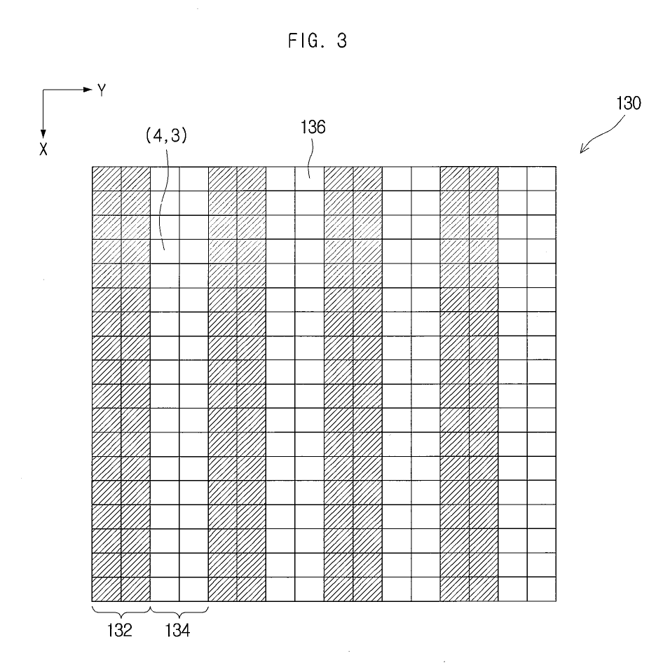

FIG. 3 shows bitmap data, illustrated on a plane, before being compensated according to a method for processing data in accordance with an embodiment of the present invention. In FIG. 3, the bitmap data 130 consists of pixels 136. Each pixel 136 has a coordinate value consisting of X, which increases in the scan direction, and Y, which is perpendicular to the scan direction X. In this case, a dot per inch (DPI) is determined according to the pixel count 136 disposed in one inch.

Next, the distance D by which the second nozzle row 120 is spaced from the first nozzle row 110 in the scan direction X is converted into a pixel count of the bitmap data 130 (S120). This will be described below step by step.

An inverse number of the DPI of the bitmap data 130 is computed as a pixel size 136 (S122). In other words, as mentioned above, since the DPI of the bitmap data 130, i.e., the pixel count disposed per inch has been determined, each of the pixel size 136 can be computed by inverting the DPI.

This can be expressed in the following equation (1).

Pixel size 136 (in micrometer)=1/DPI (1)

A quotient is obtained by dividing the distance D, by which the second nozzle row 120 is spaced from the first nozzle row 110 in the scan direction X, with the pixel size 136. Then the integer of the quotient is taken as the pixel count (S124). That is, the distance D by which the second nozzle row 120 is spaced from the first nozzle row 110 in the scan direction X is divided by the size of the pixel 136, so that it is possible to obtain how many pixels 136 on the bitmap data 130 correspond to the distance D by which the second nozzle row 120 is spaced from the first nozzle row 110 in the scan direction X.

This can be expressed in the following equation (2).

the pixel count=the spaced distance D (in micrometer)/the pixel size 136 (in micrometer) (2)

In this case, since the pixel count is an integer, only the integer is taken as the pixel count by dropping the value below the decimal point.

Such a conversion method will be described with reference to an example thereof. If the distance D by which the second nozzle row 120 is spaced from the first nozzle row 110 in the scan direction X is 1,440 μm, the distance D is converted into the pixel count of the bitmap data 130 and can be represented in the following

TABLE 1

| | Pixel size 136 (in | |
|---|---|---|
| DPI | micrometer) | Pixel count |
| 360 | 70.56 | 20 |
| 720 | 35.28 | 40 |
| 1080 | 23.52 | 61 |
| 1440 | 17.64 | 81 |
| 1800 | 14.11 | 102 |
| 2160 | 11.76 | 122 |
| 2520 | 10.08 | 142 |
| 2880 | 8.82 | 163 |
| 3240 | 7.84 | 183 |
| 3600 | 7.06 | 204 |
| 3960 | 6.41 | 224 |
| 4320 | 5.88 | 244 |
| 4680 | 5.43 | 265 |
| 5040 | 5.04 | 285 |

Subsequently, bitmap data 134 for driving the second nozzle row 120 is compensated by as much as the pixel count (S130). According to the step above, since the distance D by which the second nozzle row 120 is spaced from the first nozzle row 110 in the scan direction X can be converted into the pixel count of the bitmap data 134, it is possible to reduce an adhesion error of a drop of ink by converting the bitmap data 134 for driving the second nozzle row 120 by as much as the pixel count.

That is, in case that printing is performed by driving the nozzles 112 and 122 of the inkjet head 100 as shown in FIG. 1 with respect to the bitmap data 130 before being compensated as shown in FIG. 3, since the first nozzle row 110 is spaced from the second nozzle row 120, there occurs an error between the bitmap data 130 and a pattern actually printed on the printing object.

According to the embodiment of the present invention, after the spaced distance D between the first nozzle row 110 and the second nozzle row 120 is converted into the pixel count of the bitmap data 130, the bitmap data 130 is compensated by converting beforehand the bitmap data 130 by as much as the computed pixel count in a reverse direction to the direction in which the second nozzle row 120 is spaced from the first nozzle row 110, that is, the scan direction X. As a result, when a pattern is printed on the printing object, it is possible to cancel the error caused by the spaced distance D between the first nozzle row 110 and the second nozzle row 120.

Hereinafter, the aforesaid compensating the bitmap data 130 will be described in more detail.

As described above, after the distance D by which the second nozzle row 120 is spaced from the first nozzle row 110 in the scan direction X is converted into the pixel count, the coordinate value in the scan direction X of the bitmap data 134 for driving the second nozzle row 120 is reduced by as much as the pixel count.

That is, the bitmap data 130 can include a section 132 for driving the first nozzle row 110 and a section 134 for driving the second nozzle row 120, each of which is matched with the first nozzle row 110 and the second nozzle row 120, respectively. When the first nozzle row 110 is spaced from the second nozzle row 120, the coordinate value in the scan direction X of the bitmap data 134 for driving the second nozzle row 120 is reduced by as much as the pixel count, which corresponds to the distance D by which the second nozzle row 120 is spaced from the first nozzle row 110 in the scan direction X. Accordingly, a degree to which the second nozzle row 120 is spaced from the first nozzle row 110 in the scan direction X and a degree to which the component value in the scan direction X of the bitmap data 134 is adjusted are canceled with each other. Consequently, the adhesion error of a drop of ink being printed can be reduced.

Such an adjustment of the coordinate value can be expressed by the following equation (3).

{the component value in the scan direction X of the compensated bitmap data 144 for driving the second nozzle row 120}={the component value in the scan direction X of the bitmap data 144 before being compensated for driving the second nozzle row 120}={the pixel count converted from the distance D by which the second nozzle row 120 is spaced from the first nozzle row 110 in the scan direction X} (3)

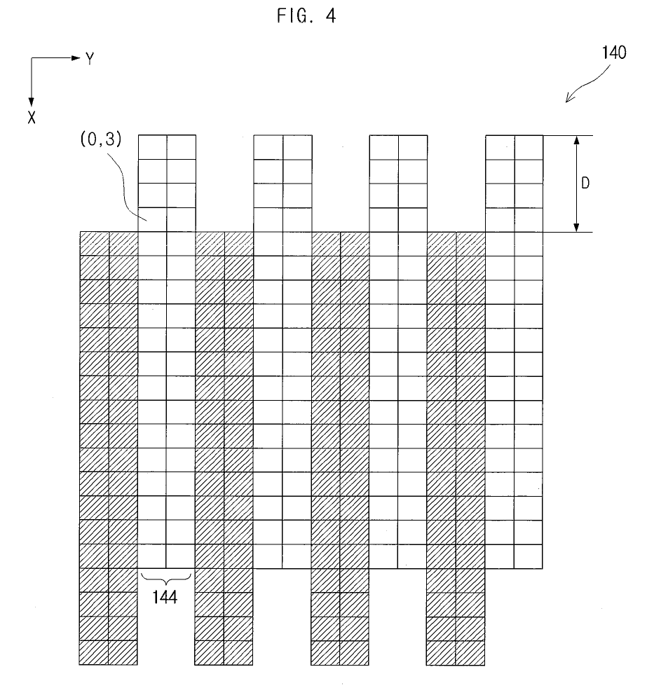

FIG. 4 is a view displaying bitmap data compensated according to a method for processing data in accordance with an embodiment of the present invention on a plane.

Hereinafter, with reference to FIGS. 3 and 4, the described adjustment of the coordinate value will be described again by taking an example of a case in which the pixel count is 4, which corresponds to the distance D by which the second nozzle row 120 is spaced from the first nozzle row 110 in the scan direction X, and a coordinate value in the scan direction X and in a perpendicular direction Y of one of the bitmap data 134 for driving the second nozzle row 120 is (4, 3).

In other words, since the coordinate value (that is, 4) in the scan direction X of the bitmap data 134 for driving the second muzzle row 120 minus the pixel count (that is, 4) converted from the distance D by which the second nozzle row 120 is spaced from the first nozzle row 110 in the scan direction X is equal to 0, a component value in the scan direction X of the bitmap data 144 for driving the second nozzle row 120 is adjusted to be 0. Eventually, the coordinate value of (4, 3) is adjusted to be (0, 3).

In the mean time, the concrete and general aspects of the method for processing data provided by the embodiment of the present invention can be tangibly implemented as a program of instructions executable by a computer and so on and can be realized in a recording medium readable by the computer, etc.

Since what is performed in each step is the same as or similar to the description mentioned above, detailed description thereof will be omitted.

Up to now, while the one embodiment of the present invention has been described, it is possible for those skilled in the art to make various changes and modifications of the forms and details of the present invention by means of addition, change, elimination or supplement, etc., of the components of the present invention without departing from the spirit of the present invention as defined by the appended claims, which also belongs to the scope of rights of the present invention.

What is claimed is:

1. A method for processing bitmap data for driving an inkjet head in which nozzle rows are spaced from one another in a scan direction, each of the nozzle rows consisting of a plurality of nozzles disposed on the same straight line, the method comprising:
converting a distance by which a second nozzle row is spaced from a first nozzle row in the scan direction into a pixel count of the bitmap data; and
compensating the bitmap data for driving the second nozzle row by as much as the pixel count.

2. The method of claim 1, wherein the converting of the spaced distance into the pixel count comprises:
computing a pixel size by inverting a dot per inch (DPI) of the bitmap data; and
computing the pixel count by taking an integer of a quotient of the spaced distance divided by the pixel size.

3. The method of claim 1, wherein the compensating of the bitmap data comprises subtracting the pixel count from a coordinate value in the scan direction of the bitmap data for driving the second nozzle row.

4. A recording media recorded with a program for realizing a method for processing bitmap data for driving an inkjet head in which nozzle rows are spaced from one another in a scan direction, each of the nozzle rows consisting of a plurality of nozzles disposed on the same straight line, the method comprising:
converting a distance by which a second nozzle row is spaced from a first nozzle row in the scan direction into a pixel count of the bitmap data; and
compensating the bitmap data for driving the second nozzle row by as much as the pixel count.

5. The recording media of claim 4, wherein the converting of the spaced distance into the pixel count comprises:
computing a pixel size by inverting a dot per inch (DPI) of the bitmap data; and
computing the pixel count by taking an integer of a quotient of the spaced distance divided by the pixel size.

6. The recording media of claim 4, wherein the compensating of the bitmap data comprises subtracting the pixel count from a coordinate value in the scan direction of the bitmap data for driving the second nozzle row.
